(19) United States
(12) Patent Application Publication
(10) Pub. No.: US 2009/0318092 A1
(43) Pub. Date: Dec. 24, 2009

(54) MULTI-ANTENNA SYSTEM FOR DIFFERENTIAL WIRELESS COMMUNICATION DEVICES

(75) Inventors: Joseph Maoz, Tel Aviv (IL); Michael Kadichevitz, Tel Aviv (IL)

Correspondence Address: MARTIN D. MOYNIHAN d/b/a PRTSI, INC., P.O. BOX 16446, ARLINGTON, VA, 22215, US

(73) Assignee: In4Tel Ltd., Herzlia Pituach (IL)

(21) Appl. No.: 12/306,937

(22) PCT Filed: Jun. 28, 2007
(86) PCT No.: PCT/IL07/00807

§ 371 Date: Dec. 30, 2008

Related U.S. Application Data
(60) Provisional application No. 60/817,380, filed on Jun. 30, 2006.

(51) Int. Cl. H04B 1/38

(52) U.S. Cl. 455/73

(57) ABSTRACT

A multi-antenna system for differential wireless communication devices, such as transceivers, transmitters or receivers, includes a wireless communication device having a differential port including first and second nodes and a common ground for an antenna connection; a first antenna connected between the first node and the common ground; and a second antenna connected between the second node and the common ground.

### FIELD AND BACKGROUND OF THE INVENTION

The present invention relates to multi-antenna systems for differential wireless communication devices. The invention is particularly useful in a dual antenna system with transceivers, and is therefore described below with respect to such an application, but it will be appreciated that the invention could advantageously be used for transmitters and/or receivers alone.

In traditional transceiver (transmitter and receiver) communication systems, the transceiver has a single-ended RF signal (either input or output) connected to the IF circuit, and a differential IF signal (either output or input) at the other end. This is done to implement the transceiver circuit and to enhance its noise immunity.

A single ended (unbalanced) signal is one in which a single line transmits the signal with reference to the ground of the circuit. A differential (balanced) signal is one in which two anti-phase (180°) lines transmit the signal with reference to a mutual ground.

In most cases, the antenna is single ended: that is, the antenna has one signal connection and one ground connection. Accordingly, a Balun (balance-to-unbalance) is frequently used. The Balun is a passive device that transforms the differential signal into a single-ended signal. Naturally, the Balun has considerable RF loss, and additional cost to the Bill of Material (BOM) of the circuit, and requires more space on the PCB.

Modern communication systems are required to be small and efficient with full spatial coverage. This coverage requirement is usually met by the use of dual (and more) antennas even at the cost of extra circuits, space, BOM, complexity, etc.

Diversity architecture for enhancing links of a wireless communication system is a well known technology and has become very popular in recent years. Known diversity antenna configurations include: spatial diversity, where each of the antennas covers different parts of the space; polarization diversity, where the polarization of each of the antennas is orthogonal to the other; and time diversity, where the two antennas are delayed relative to each other. The diversity architecture is driven by a switch which chooses the best performing antenna, and disconnects the other antenna, or by using comparators and phase shifters then combining the signals. The switching control is usually sampled at a low rate such that it will not interfere with the system performance and order.

An improvement to the traditional diversity mechanism was developed recently, where each antenna is driven by a separate transceiver, and the IF signals of both channels are then combined by first shifting, and then adjusting the phase, of one channel to match the phase of the other channel. However, such an arrangement increases the cost significantly, and requires two separate channels and signal processing. Accordingly, such an arrangement may not be practical for real time high speed systems.

Power amplifiers, transmitters, receivers and transceivers are very often built with differential ports, which is the natural output of such components. As indicated earlier, in many circuits a Balun (balance to unbalance) is added to achieve a single-ended port, usually having 50 ohm output impedance. The output differential impedance is usually 100 ohms. However, as also indicated earlier, the use of Baluns increases the overall system cost, reduces the efficiency by increasing the insertion loss, and enlarges the PCB area.

### OBJECTS AND BRIEF SUMMARY OF THE PRESENT INVENTION

An object of the present invention is to provide a multi-antenna system for differential wireless communication devices having advantages in one or more of the above respects.

According to a broad aspect of the present invention, there is provided a multi-antenna system comprising: a wireless communication device having a differential port including first and second nodes and a common ground for an antenna connection; a first antenna connected between the first node and the common ground; and a second antenna connected between the second node and the common ground.

The present invention thus provides a new multi-antenna configuration which is suitable for use with any differential port of a radio transceiver. It enables the benefit of a dual antenna operation with any of the above-mentioned configurations, without the need for a switching circuit, two separate transceivers (transmitters, receivers or transceivers) and mechanism for processing two separate signals. The two signals of a differential port transmitted or received by the two antennas are considered as the most regular case of multi-path, as they are transmitted or received by a single differential port of the transceiver. The two antennas are in fact connected serially, rather than in parallel, yet are capable of being effectively operated over a very wide band of frequencies. The limit is only the question of the antenna type used. The first antenna is connected between the positive node and the common ground node, while the second antenna is connected between the negative node and the common ground node. Such connections would be considered as going against the conventional wisdom in this field since the two antennas inherently have opposite phases (180 degrees) relative to each other. However, and as will be shown, the latter can be ignored in some of the embodiments or overcome in other embodiments of the present invention.

The invention is described below, for purposes of example, as embedded in systems wherein the antennas are located in different planes at an angle to each other, and in perpendicular planes relative to each other, in the same plane but at a distance from each other. The invention is also described below in other embodiments wherein the two antennas are orthogonally polarized with respect to each other, or include feed lines of different lengths, or of different characteristic impedance, or of different phases. The invention is also described below with respect to systems wherein the two antennas have different input impedances, or different radiation patterns.

As indicated above, the invention is particularly useful with respect to transceivers, but may also be used with respect to transmitters or receivers alone.

Further features and advantages of the invention will be apparent from the description below.

### BRIEF DESCRIPTION OF THE DRAWINGS

The invention is herein described, by way of example only, with reference to the accompanying drawings, wherein:

FIG. 1 illustrates a typical prior art wireless communication system relevant to the present invention;

FIG. 2 also illustrates a typical prior art wireless communication system in which the system of FIG. 1 is duplicated for each antenna;

FIG. 3 illustrates one form of multi-antenna system constructed in accordance with the present invention;

FIG. 4 illustrates a system similar to that of FIG. 3, in which the antennas are directed in the same direction but have different polarizations;

FIG. 5 illustrates a system in accordance with the present invention wherein the antennas are located in different planes at an angle relative to each other, particularly in perpendicular planes relative to each other;

FIG. 6 illustrates a system similar to that of FIG. 5, but including a phase shifter;

FIG. 7 illustrates a system similar to that of FIG. 4, but wherein the antennas are located in perpendicular planes to each other;

FIG. 8 illustrates a system constructed in accordance with the present invention including antennas of different types and/or shapes;

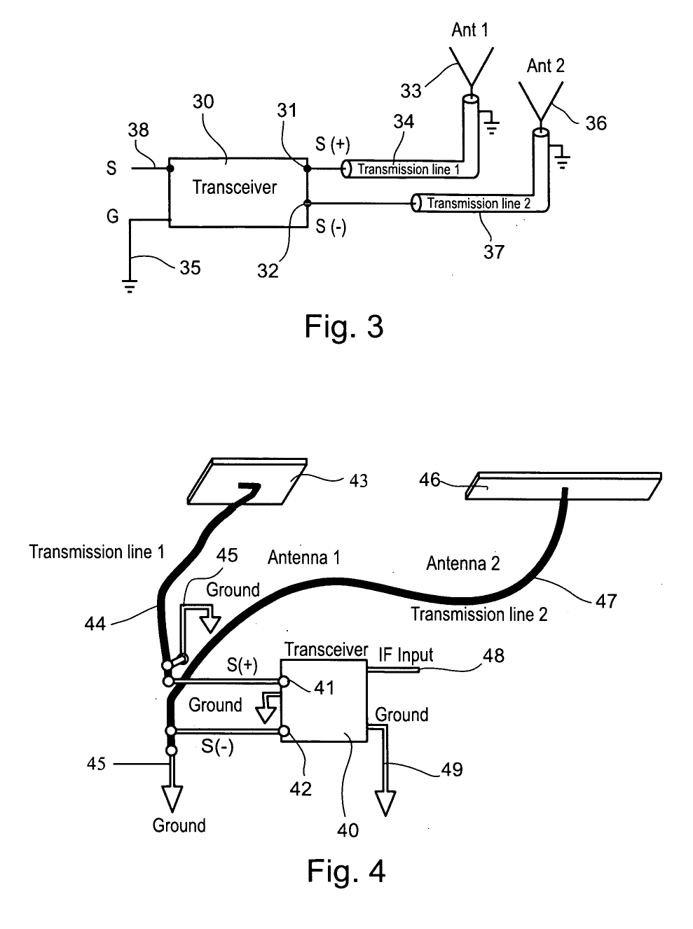

and FIG. 9 illustrates a system similar to that of FIG. 3, but including a pair of transceivers each connected to a dual antenna.

It is to be understood that the foregoing drawings, and the description below, are provided primarily for purposes of facilitating understanding the conceptual aspects of the invention and possible embodiments thereof, including what is presently considered to be a preferred embodiment. In the interest of clarity and brevity, no attempt is made to provide more details than necessary to enable one skilled in the art, using routine skill and design, to understand and practice the described invention. It is to be further understood that the embodiments described are for purposes of example only, and that the invention is capable of being embodied in other forms and applications than described herein.

### THE PRIOR ART

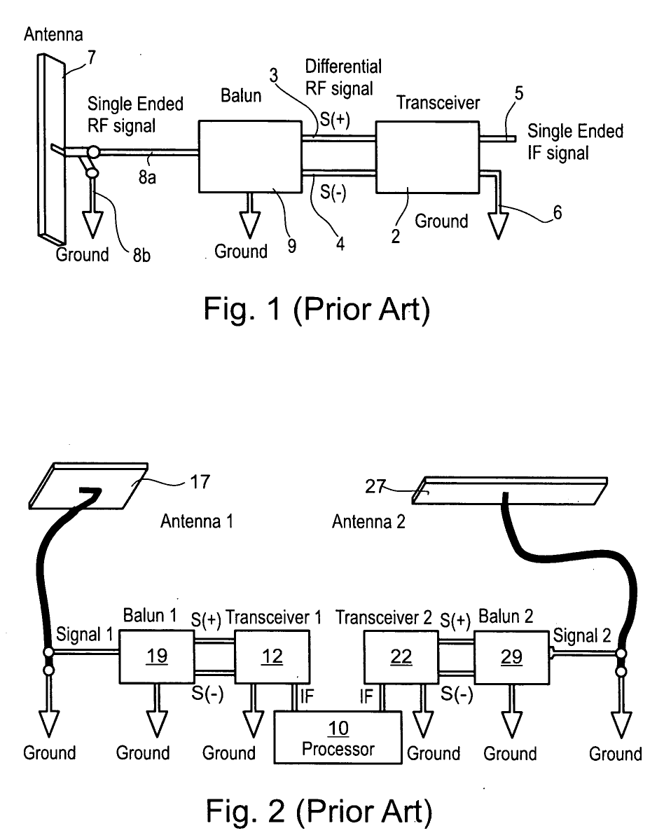

FIG. 1 illustrates a typical communication system in accordance with the prior art, wherein the transceiver 2 has a single ended IF signal (either input or output) connected to the IF circuit, and a differential RF signal (either output or input) at the other end. This is done to implement the transceiver circuit and to enhance its noise immunity.

In the example illustrated in FIG. 1, the differential RF signal is the input to the transceiver, as shown by lines 3, 4, whereas the single-ended IF signal is the output signal outputted via line 5 with respect to ground 6. The differential RF signal inputted via lines 3 and 4 divides the signal into two anti-phase (180°) transmitted by the two lines 3, 4 with reference to the neutral ground 6.

As indicated earlier, in most cases the antenna, designated 7 in FIG. 1, is single ended; that is, the antenna has one signal connection 8a and one ground connection 8b. Accordingly, the system includes a Balun 9, which is a passive device that transforms the single-ended RF signal from the antenna into a differential signal to be applied at the input terminals, 3, 4 of the transceiver 2. However, as also indicated earlier, the Balun has considerable RF loss and involves significant additional costs.

FIG. 2 illustrates a typical prior art system using two transceivers 12, 22, having two antennas 17, 27, and two Baluns 19, 29. The system illustrated in FIG. 2 further includes a processor generally designated 10 which processes the IF signals outputted from the two transceivers 12, 22. The two antennas 17, 27 are placed to achieve maximum spatial coverage and have either the same polarization or orthogonal polarizations. Such a system, therefore, would have the same drawbacks as the system described in FIG. 1.

### DESCRIPTION OF PREFERRED EMBODIMENTS

FIG. 3 illustrates a dual-antenna system for a differential transceiver, generally designated 30, constructed in accordance with the present invention. In this case, transceiver 30 includes a differential input port including a first node 31 and a second node 32. One antenna 33 is connected, via transmission line 34, between the first node 31 and the common ground 35; whereas the second antenna 36 is connected, via transmission line 37, between the second node 32 and the common ground 35. For example, the differential port, nodes 31 and 32, could be of 100 ohms, whereas each of the antennas 33, 36 could be of 50 ohms.

The other side of transceiver 30 includes a single-ended signal port 38 for the signal with reference to the ground of the circuit.

Thus, the two antennas 33, 36 may be configured for orthogonal polarization, in orthogonal planes, in the same plane but at a distance from each other, with different time delays, with feed lines differing in length, with a different characteristic impedances, etc. Circular polarization or any other delay/phase difference between the two antennas can be made in a simple manner.

It will be thus be seen that the two antennas 33, 36 in the system of FIG. 3 are connected to a differential signal port, and achieve the benefit of better coverage and better signal-to-noise ratio at the receiver.

FIG. 4 illustrates a system similar to that of FIG. 3, with the transceiver 40 having a differential port including a first node 41 and a second node 42, connected to the two antennas 43, 46. Antenna 43 is connected, via transmission line 44, between the first node 41 and the common ground 54; whereas the second antenna 46 is connected, via transmission line 47, between the second node 42 and common ground 45.

As shown in FIG. 4, the opposite side of transceiver 40 receives or output a single ended signal applied between port 48 and the common ground 49.

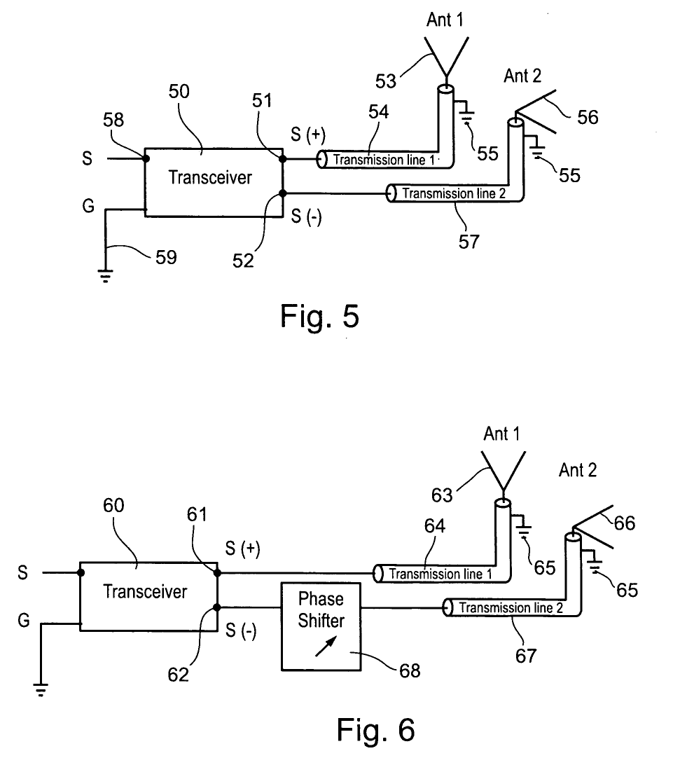

FIG. 5 illustrates a system similar to that of FIG. 3, except the second antenna 56 has a polarization orthogonal to the polarization of the first antenna 53. Thus, as shown in FIG. 5, antenna 53 is connected, via transmission tine 54, between the first node 51 of transceiver 50 and the common ground 55; whereas the second antenna 56 is connected, via transmission line 57, between the second node 52 of the transceiver and the common ground 55. The opposite side of transceiver 50 receives (or outputs) a single-ended signal between port 58 and ground 59.

In many wireless systems, the power limitation is measured on each polarization separately, and therefore the division of the power into two orthogonal polarizations enables the power to be increased by close to 3 dB relative to a single polarization structure. Another benefit of such a configuration is achieved when using the wireless system inside buildings, where multi-path signals are generated, the polarization diversity advantages are achieved without the need for a second transmitter, receiver or transceiver, nor the need for signal processing of the two antennas, as described above with respect to the prior art system of FIG. 2.

FIG. 6 illustrates a system similar to that of FIG. 5, except that the second antenna excitation 66 has a phase difference relative to that of the first antenna 63. FIG. 6 shows this by the addition of a phase shifter 68 between the second node 62 of transceiver 60 and the transmission line 67 to the second antenna 66. Such a configuration improves the system link by reducing the effect of blind points. It will be appreciated that in addition to including a phase shifter, or in lieu of a phase shifter, the same delay may be achieved by making the two transmission lines 64, 67 of the two antennas 63, 66 of different lengths, as in FIG. 4.

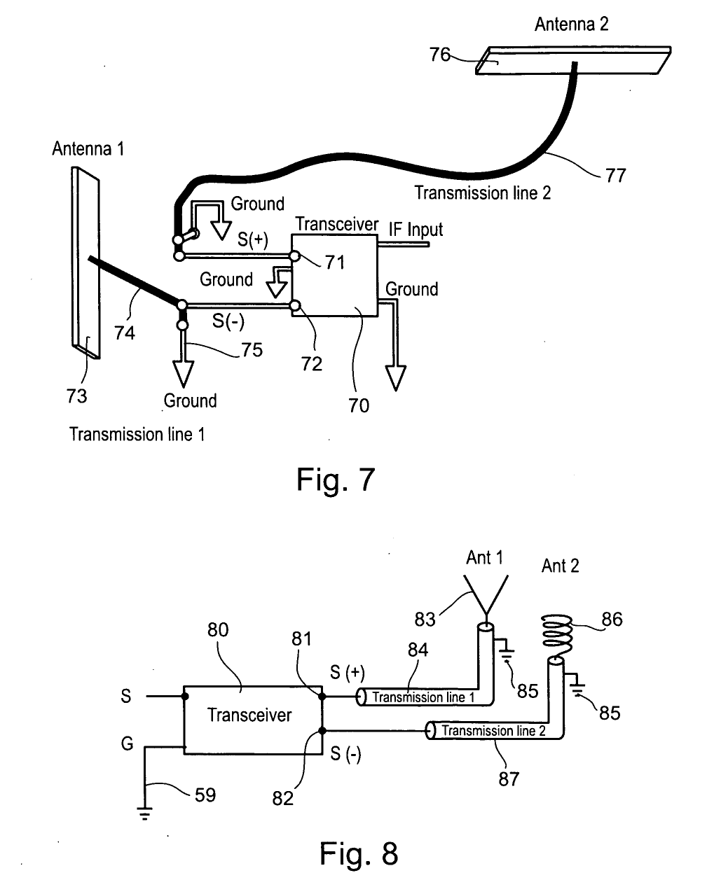

FIG. 7 illustrates such a system wherein a phase shift is effected between the two antennas 73, 76, by making the transmission line 77 of one antenna 76 substantially longer than the transmission line 74 of the other antenna 73. Thus, in the system illustrated in FIG. 7, the signal from antenna 73 is fed, via the shorter transmission line 74, between the first node 71 of transceiver 70 and the common ground 75; whereas the signal from the second antenna 76 is fed, via the longer transmission line 77, between the second node 72 of transceiver 70 and the common ground 75

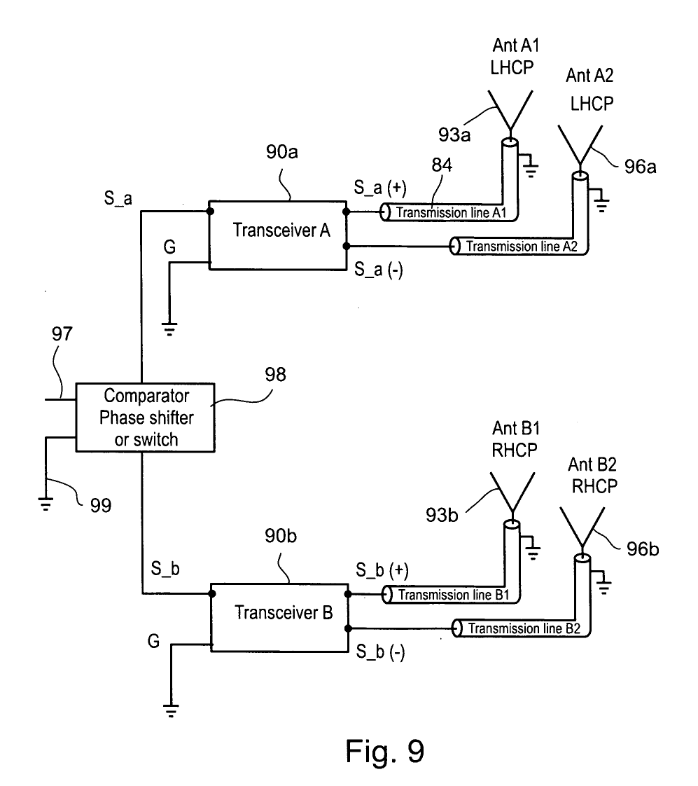

FIG. 8 illustrates a system including two different types of antennas, as shown at 83 and 86, respectively. As an example, both antennas may have the same polarization, but with complementary patterns. When both antennas are located in the same plane in a way that the main lobe of the second antenna is in the direction of the null of the first antenna, full spatial coverage can be achieved. The system illustrated in FIG. 8 is otherwise constructed and operated in a similar manner as described above, with the signal antenna 83 being connected, via transmission line 84, between the first node 81 of transceiver 80 and the common ground 85; and the signal from the second antenna 86 being applied, via transmission line 87, between the second node 82 of the transceiver and common ground 85.

FIG. 9 illustrates a further embodiment of the invention, wherein a pair of transceivers 90a, 90b are used, each connected to a pair of dual antennas 93a, 93b and 96a, 96b, respectively. The two pairs of dual antennas are structured for orthogonal polarization to each other. For example, one pair of the dual antennas may be connected to its respective transceiver and may be structured to perform a left-hand circular polarization, while the other pair of dual antennas may be connected to its respective transceiver and may be structured to perform a right-hand circular polarization. A device 98, such as a comparator, phase shifter or switch is then used to choose the best received signal, or to modify one signal with respect to the other and combine the two signals for inputting (or outputting) the single ended signal between port 98 and the common ground 99.

Thus, the blind points of one transceiver caused by cancellation of the signal due to opposite phases in each of the relevant pair of antennas, will be covered by the second transceiver which will present in phase signals in each of the other pair of antennas. As a result, the overall system performance will be dramatically improved.

It will be seen that the present invention, as described above with respect to several preferred embodiment, improves the overall system performance, especially in the blind points of a single antenna. The designer may then fully optimize the spatial distance and orientation of the two antennas relative to each other to maximize the system performance. Naturally, combinations of the above-described embodiments are possible depending on the application and the requirements.

While the invention has been described with respect to several preferred embodiments, it will be appreciated that these are set forth merely for purposes of example, and that many other variations, modifications and applications of the invention may be made.

What is claimed is:

1. A multi-antenna system for differential wireless communication devices, comprising:
a wireless communication device having a differential port including first and second nodes and a common ground for an antenna connection;
a first antenna connected between said first node and the common ground;
and a second antenna connected between said second node and the common ground.

2. The system according to claim 1, wherein the antennas are located in different planes at an angle relative to each other.

3. The system according to claim 1, wherein the antennas are located in perpendicular planes relative to each other.

4. The system according to claim 1, wherein the antennas are located in the same plane but at a distance from each other.

5. The system according to claim 1, wherein said antennas are orthogonally polarized with respect to each other.

6. The system according to claim 1, wherein the antennas differ from each other in type and/or shape.

7. The system according to claim 1, wherein one of said antennas is delayed in time relative to the other antenna.

8. The system according to claim 1, wherein the two antennas include feed lines of different lengths.

9. The system according to claim 1, wherein the two antennas include feed lines of different characteristic impedance.

10. The system according to claim 1, wherein the feed of the two antennas are in different phases.

11. The system according to claim 1, wherein the two antennas have different input impedances.

12. The system according to claim 1, wherein the two antennas differ in radiation pattern coverage.

13. The system according to claim 1, wherein said wireless communication device is a transceiver, a transmitter or a receiver.

14. The system according to claim 1, wherein said system further comprises:
a second wireless communication device having a differential port including first and second nodes and a common ground for an antenna connection;
a third antenna connected between said first node and the common ground of said second wireless communication device;
a fourth antenna connected between said second node and the common ground of said second wireless communication device;
said first and second antenna being structured to perform a first polarization;
said third and fourth antennas being structured to perform a second polarization which is orthogonal to said first polarization;
and an electrical device for selecting the best signal, or for modifying one signal and combining it with the other signal, of said two wireless communication devices.

15. The system according to claim 14, wherein said first and second antennas are structured to perform left-hand circular polarization; and
said third and fourth antennas are structured to perform righ-hand circular polarization.

16. The system according to claim 14, wherein said electrical device is a comparator, a phase shift, or a switch.
